(19) United States
(12) Patent Application Publication
(10) Pub. No.: US 2010/0007930 A1
(43) Pub. Date: Jan. 14, 2010

(54) Authentication Scanner

(75) Inventors: Russell Paul Cowburn, London (GB); Peter Robert Seem, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: INGENIA HOLDINGS (UK) LIMITED, London (GB)

(21) Appl. No.: 12/501,303

(22) Filed: Jul. 10, 2009

Related U.S. Application Data
(60) Provisional application No. 61/079,981, filed on Jul. 11, 2008.

(30) Foreign Application Priority Data
Jul. 11, 2008 (GB) 0812772.2

(51) Int. Cl. H04N 1/04

(52) U.S. Cl. 358/488; 382/218

(57) ABSTRACT

A system for obtaining a signature from a scan area on the surface of an article comprises: a signature generator that generates the signature from scattered coherent radiation detected from a plurality of points on the surface and includes a scan head comprising a coherent radiation source and photodetectors; a camera for capturing an image of the surface; a comparator that compares the captured image with a reference image to determine the location and orientation of the scan area; and a drive assembly that positions the scan head appropriately for generating a signature from the scan area in response to the determination of the location and orientation of the scan area.

### BACKGROUND OF THE INVENTION

The present invention relates to a scanner for obtaining a signature from an article which can be used for authentication of the article, and a method for obtaining such a signature.

Many traditional authentication systems rely on a process which is difficult for anybody other than the manufacturer to perform, where the difficulty may be imposed by expense of capital equipment, complexity of technical know-how or preferably both. Examples are the provision of a watermark in bank notes and a hologram on credit cards or passports. Unfortunately, criminals are becoming more sophisticated and can reproduce virtually anything that original manufacturers can do. Furthermore, such systems are typically too expensive and complicated for tasks such as product tracking for quality control and warranty purposes.

Because of this, there is a known approach to authentication systems which relies on creating security tokens using some process governed by laws of nature which results in each token being unique, and more importantly having a unique characteristic that is measurable and can thus be used as a basis for subsequent verification. According to this approach tokens are manufactured and measured in a set way to obtain a unique characteristic. The characteristic can then be stored in a computer database, or otherwise retained. Tokens of this type can be embedded in the carrier article, e.g. a banknote, passport, ID card, important document. Subsequently, the carrier article can be measured again and the measured characteristic compared with the characteristics stored in the database to establish if there is a match. However, such systems are often still too expensive and/or complicated for tasks such as product tracking for quality control and warranty purposes.

James D. R. Buchanan et al in “Forgery: ‘Fingerprinting’ documents and packaging”, Nature 436, 475-475 (28 Jul. 2005) describes a system for using reflected laser light from an article to uniquely identify the article with a high degree of reproducibility not previously attained in the art. Buchanan's technique samples reflections from an article surface a number of times at each of multiple points in the surface to create a signature or “fingerprint” for the article.

However, identification methods which measure reflected light can be sensitive to the orientation of the incident and reflected light with respect to the surface. The present invention addresses this problem.

### SUMMARY OF THE INVENTION

Accordingly, a first aspect of the present invention is directed to a system for obtaining a signature from an article, the article having a scan area on a surface of the article from which a signature of the article may be read, the system comprising: a signature generator operable to generate a signature from the article by directing coherent radiation onto a plurality of regions in the scan area; collecting a set comprising groups of data points from signals obtained when the coherent radiation scatters from the regions in the scan area wherein different ones of the groups of data points relate to scatter from the respective different regions of the scan area; and determining a signature of the article from the set of data points; the signature generator including a scan head comprising an optical source operable to direct coherent radiation onto the scan area and a detector arrangement operable to collect the data points by detecting the scattered coherent radiation; a camera operable to capture an image of the surface of the article; an image comparator operable to compare the captured image with a reference image of an article of the same class which includes the scan area of that article, to determine the location and orientation of the scan area on the said article; and a drive assembly operable to position the scan head in a location and orientation suitable for generating a signature from the scan area on the article, in response to the determination of the location and orientation of the scan area.

Such a system improves upon the advantages of using scattered coherent light to produce a unique signature for an article. For authentication, signatures from genuine articles can be stored in a database, which is then searched for a match with a signature obtained from an article which is to be authenticated. The signature is read from a particular area on the article surface. It may be that on re-reading the signature, the article is not aligned with the scan head in the same way as when the signature was first read for storage in the database, so that the collected data is skewed. It is possible to rotate the data after collection to correct for misalignment, but it has been found that this gives inferior results compared to collecting the data at the correct alignment. To ensure correct alignment, a reader apparatus can be provided with alignment guides or apertures against which the article is positioned to orient it correctly with respect to the scan head. However, this requires a user to participate in the alignment process, and may slow down the scanning process. In contrast, the present invention provides for automatic alignment between the scan head and the article, with no effort required from the user. This simplifies the scanning and improves accuracy, thereby reducing the number of erroneous authentication results, in particular reducing rejection of authentic articles caused by a poor scanning technique.

The system specified above generates a signature for the article. The signature can be stored in a database for future authentication of the article, or it may be checked against previously stored signatures to check the authenticity of the article. In the latter case, the system may further comprise a signature comparator operable to compare the signature of the article with one or more stored signatures of articles; and a determiner operable to determine an authentication result based on the result of the comparison by the signature comparator.

The drive assembly may be operable to translate, rotate, or translate and rotate the scan head to position the scan head. The choice will depend on factors such as the desired size, cost and complexity of the system, and how much movement is needed to properly position the scan head. For example, if the scan area is relatively large compared to the imaged area, less movement of the scan head will be necessary.

The drive assembly may be further operable to move the scan head relative to the article to collect the data points. This dual functionality for the drive assembly reduces the number of components required in the system. However, a separate drive assembly to provide movement for the scan may be preferred.

In some embodiments, at least the scan head, the camera and the drive assembly are arranged within a housing suitable for hand-held use in which a user can place the housing against a surface of an article. This provides a convenient portable scanning device which is easy to use. The user need pay little regard to positioning the housing correctly against the article, since the system will automatically orient itself for accurate reading of the signature. A hand-held device is useful for scanning signatures from large and/or heavy articles.

Alternatively, at least the scan head, the camera and the drive assembly are arranged within a housing onto which an article can be placed for imaging and generation of its signature. A larger apparatus of this type, perhaps similar to a photocopier, may be preferred if portability is not required and the articles can be conveniently handled. A user can easily place an article onto the housing to read its signature, without the need to orient and align the article. Additionally, an automatic article feeder may be mounted on the housing, operable to supply a succession of articles onto the housing. In this way, automated scanning of a large plurality of articles, such as a stack of documents, can be carried out as a single uninterrupted process. This would be useful for acquiring signatures from a multiplicity of new authentic articles to populate a database for later use in authenticating articles of that type, for example.

The system may further comprise an alert device operable to deliver an alert signal to a user in the event that the image comparator is unable to determine the location and position of the scan area from the captured image. This makes the user aware that he has applied the system to an entirely incorrect part of the article, such as if the article is upside-down. In such a case, the signature cannot be generated, and either the system or the article needs to be relocated.

For simplicity, the reference image may be an image of a single article of the same class. Alternatively, the reference image may be an image composed from two or more images of articles of the same class. This allows any individual variation in the surface pattern of the articles to be smoothed out, so that the captured image can be more accurately aligned to the reference image.

If the system is for use in scanning different classes of article, the reference image may be held in a database of reference images of articles of different classes. The appropriate reference image can be retrieved from the database to allow positioning of the scan head.

The reference image may be smaller in area than the captured image. This reduces the amount of image data that needs to be stored, while at the same time improving the alignment ability of the system since it is more likely that the scan area will be encompassed within the captured image so that the scan head can be positioned appropriately. For example, in some embodiments, the camera is able to capture an image of the entirety of the surface of the article having the scan area. This means that, so long as the correct surface of the article is presented for scanning, the scan area can always be located and the signature read. To achieve this, only a small reference image, including the scan area and a recognisable adjacent pattern, is needed.

A second aspect of the present invention is directed to a method for obtaining a signature from an article, the article having a scan area on a surface of the article from which a signature of the article may be read, the method comprising: capturing an image of the surface of the article; comparing the captured image with a reference image of an article of the same class which includes the scan area of that article, to determine the location and orientation of the scan area on the said article; and generating a signature from the article by directing coherent radiation onto a plurality of regions in the scan area; collecting a set comprising groups of data points from signals obtained when the coherent radiation scatters from the regions in the scan area wherein different ones of the groups of data points relate to scatter from the respective different regions of the scan area; and determining a signature of the article from the set of data points; the signature being generated using a scan head comprising an optical source operable to direct coherent radiation onto the scan area and a detector arrangement operable to collect the data points by detecting the scattered coherent radiation; wherein the scan head is positioned in a location and orientation suitable for generating a signature from the scan area on the article in response to the determination of the location and orientation of the scan area.

### BRIEF DESCRIPTION OF THE DRAWINGS

For a better understanding of the invention and to show how the same may be carried into effect reference is now made by way of example to the accompanying drawings in which:

FIG. 1 shows a schematic side view of a reader apparatus;

FIG. 2 shows a block schematic diagram of functional components of the reader apparatus of FIG. 1;

FIG. 3 is a microscope image of a paper surface;

FIG. 4 shows an equivalent image for a plastic surface;

FIG. 5 shows a flow diagram showing how a signature of an article can be generated from a scan;

FIG. 6 is a flow diagram showing how a signature of an article obtained from a scan can be verified against a signature database;

FIGS. 7a and 7b are plots illustrating how a number of degrees of freedom can be calculated;

FIG. 8 is a flow diagram showing the overall process of how a document is scanned for verification purposes and the results presented to a user;

FIGS. 9a and 9b are flow diagrams showing examples of how the verification process of FIG. 6 can be altered to account for non-idealities in a scan;

FIG. 10a shows an example of cross-correlation data gathered from a scan;

FIG. 10b shows an example of cross-correlation data gathered from a scan where the scanned article is distorted;

FIG. 10c shows an example of cross-correlation data gathered from a scan where the scanned article is scanned at non-linear speed;

FIG. 11 shows a simplified schematic representation of a reader apparatus according to an embodiment of the invention;

FIGS. 12A-12D show an article to be scanned and images for use in scanning the article according to an embodiment of the invention;

FIG. 13 is a flow chart showing a method for scanning an article according to an embodiment of the invention; and

FIG. 14 shows a simplified schematic representation of a reader apparatus according to a further embodiment.

While the invention is susceptible to various modifications and alternative forms, specific embodiments are shown by way of example in the drawings and are herein described in detail. It should be understood, however, that the drawings and detailed description are not intended to limit the invention to the particular form disclosed, but on the contrary, the invention is to cover all modifications, equivalents and alternatives falling within the spirit and scope of the present invention as defined in the appended claims.

### DETAILED DESCRIPTION

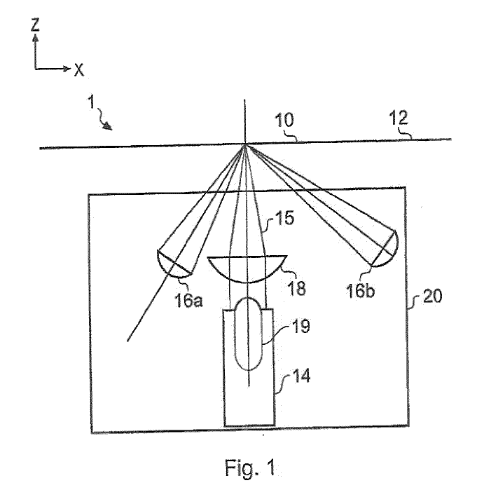

To provide an accurate method for uniquely identifying an article, it is possible to use a system which relies upon optical reflections from a surface of the article. An example of such a system will be described with reference to FIGS. 1 to 10.

The example system described herein is one developed and marketed by Ingenia Technologies Ltd. This system is operable to analyse the random surface patterning of a paper, cardboard, plastic or metal article, such as a sheet of paper, an identity card or passport, a security seal, a payment card etc to uniquely identify a given article. This system is described in detail in a number of published patent applications, including GB0405641.2 filed 12 Mar. 2004 (published as GB2411954 14 Sep. 2005), GB0418138.4 filed 13 Aug. 2004 (published as GB2417707 8 Mar. 2006), U.S. 60/601,464 filed 13 Aug. 2004, U.S. 60/601,463 filed 13 Aug. 2004, U.S. 60/610,075 filed 15 Sep. 2004, GB 0418178.0 filed 13 Aug. 2004 (published as GB2417074 15 Feb. 2006), U.S. 60/601,219 filed 13 Aug. 2004, GB 0418173.1 filed 13 Aug. 2004 (published as GB2417592 1 Mar. 2006), U.S. 60/601,500 filed 13 Aug. 2004, GB 0509635.9 filed 11 May 2005 (published as GB2426100 15 Nov. 2006), U.S. 60/679,892 filed 11 May 2005, GB 0515464.6 filed 27 Jul. 2005 (published as GB2428846 7 Feb. 2007), U.S. 60/702,746 filed 27 Jul. 2005, GB 0515461.2 filed 27 Jul. 2005 (published as GB2429096 14 Feb. 2007), U.S. 60/702,946 filed 27 Jul. 2005, GB 0515465.3 filed 27 Jul. 2005 (published as GB2429092 14 Feb. 2007), U.S. 60/702,897 filed 27 Jul. 2005, GB 0515463.8 filed 27 Jul. 2005 (published as GB2428948 7 Feb. 2007), U.S. 60/702,742 filed 27 Jul. 2005, GB 0515460.4 filed 27 Jul. 2005 (published as GB2429095 14 Feb. 2007), US 60/702,732 filed 27 Jul. 2005, GB 0515462.0 filed 27 Jul. 2005 (published as GB2429097 14 Feb. 2007), U.S. 60/704,354 filed 27 Jul. 2005, GB 0518342.1 filed 8 Sep. 2005 (published as GB2429950 14 Mar. 2007), U.S. 60/715,044 filed 8 Sep. 2005, GB 0522037.1 filed 28 Oct. 2005 (published as GB2431759 2 May 2007), and U.S. 60/731,531 filed 28 Oct. 2005 (all invented by Cowburn et al.), the content of each and all of which is hereby incorporated hereinto by reference.

By way of illustration, a brief description of the method of operation of the Ingenia Technologies Ltd system will now be presented.

FIG. 1 shows a schematic side view of an example of a reader apparatus or scanner apparatus 1. The optical reader apparatus 1 is for measuring a signature from an article (not shown) arranged in a reading volume of the apparatus. The reading volume is formed by a reading aperture 10 which is a slit in a housing 12. The housing 12 contains the main optical components of the apparatus. The slit has its major extent in the x direction (see inset axes in the drawing). The principal optical components are a laser source 14 for generating a coherent laser beam 15 and a detector arrangement 16 made up of a plurality of k photodetector elements, where k=2 in this example, labelled 16a and 16b. The laser beam 15 is focused by a focussing arrangement 18 into an elongate focus extending in the y direction (perpendicular to the plane of the drawing) and lying in the plane of the reading aperture. In one example reader, the elongate focus has a major axis dimension of about 2 mm and a minor axis dimension of about 40 micrometres. These optical components are contained in a subassembly or scan assembly 20. In the illustrated example, the detector elements 16a, 16b are distributed either side of the beam axis offset at different angles from the beam axis to collect light scattered in reflection from an article present in the reading volume. In one example, the offset angles are −30 and +50 degrees. The angles either side of the beam axis can be chosen so as not to be equal so that the data points they collect are as independent as possible. However, in practice, it has been determined that this is not essential to the operation and having detectors at equal angles either side of the incident beam is a perfectly workable arrangement. In examples having more than two detector elements (k>2), all the detector elements may be arranged in a common plane. The photodetector elements 16a and 16b detect light scattered from an article placed on the housing when the coherent beam scatters from the reading volume. As illustrated, the source is mounted to direct the laser beam 15 with its beam axis in the z direction, so that it will strike an article in the reading volume at normal incidence.

Generally it is desirable that the depth of focus is large, so that any differences in the article positioning in the z direction do not result in significant changes in the size of the beam in the plane of the reading aperture. In one example, the depth of focus is approximately ±2 mm which is sufficiently large to produce good results. In other arrangements, the depth of focus may be greater or smaller. The parameters of depth of focus, numerical aperture and working distance are interdependent, resulting in a well known trade off between spot size and depth of focus. In some arrangements, the focus may be adjustable, and in conjunction with a range-finding means the focus may be adjusted to target an article placed within an available focus range.

In order to enable a number of points on the target article to be read (scanning the article), the article and reader apparatus can be arranged so as to permit the incident beam and associated detectors to move relative to the target article. This can be arranged by moving the article, the scan assembly or both. In some examples, the article may be held in place adjacent the reader apparatus housing and the scan assembly may move within the reader apparatus to cause this movement. Alternatively, the article may be moved past the scan assembly, for example in the case of a production line where an article moves past a fixed position scanner while the article travels along a conveyor. In other alternatives, both article and scanner may be kept stationary, while a directional focus means causes the coherent light beam to travel across the target. This may require the detectors to move with the light beam, or stationary detectors may be positioned so as to receive reflections from all incident positions of the light beam on the target.

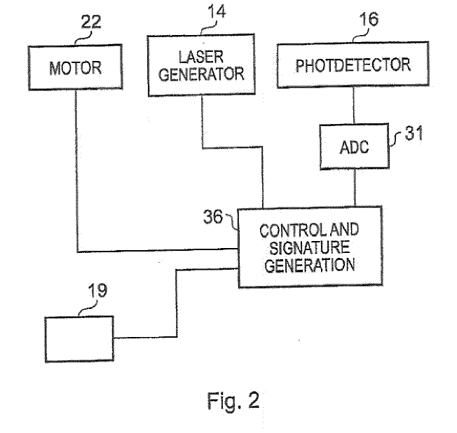

FIG. 2 is a block schematic diagram of logical components of a reader apparatus as discussed above. A laser generator 14 is controlled by a control and signature generation unit 36. Optionally, a motor 22 may also be controlled by the control and signature generation unit 36. Optionally, if some form of motion detection or linearization means (shown as 19) is implemented to measure motion of the target past the reader apparatus, and/or to measure and thus account for non-linearities in their relative movement, this can be controlled using the control and signature generation unit 36.

The reflections of the laser beam from the target surface scan area are detected by the photodetector 16. As discussed above, more than one photodetector element may be provided in some examples. The output from the photodetector 16 is digitised by an analog to digital converter (ADC) 31 before being passed to the control and signature generation unit 36 for processing to create a signature for a particular target surface scan area. The ADC can be part of a data capture circuit, or it can be a separate unit, or it can be integrated into a microcontroller or microprocessor of the control and signature generation unit 36.

The control and signature generation unit 36 can use the laser beam present incidence location information to determine the scan area location for each set of photodetector reflection information. Thereby a signature based on all or selected parts of the scanned part of the scan area can be created. Where less than the entire scan area is being included in the signature, the signature generation unit 36 can simply ignore any data received from other parts of the scan area when generating the signature. Alternatively, where the data from the entire scan area is used for another purpose, such as positioning or gathering of image-type data from the target, the entire data set can be used by the control and signature generation unit 36 for that additional purpose and then kept or discarded following completion of that additional purpose.

As will be appreciated, the various logical elements depicted in FIG. 2 may be physically embodied in a variety of apparatus combinations. For example, in some situations, all of the elements may be included within a reader apparatus. In other situations, the reader apparatus may include only the laser generator 14, motor 22 (if any) and photodetector 16 with all the remaining elements being located in a separate physical unit or units. Other combinations of physical distribution of the logical elements can also be used. Also, the control and signature generation unit 36 may be split into separate physical units. For example, there may be a first unit which actually controls the laser generator 14 and motor (if any), a second unit which calculates the laser beam current incidence location information, a third unit which identifies the scan data which is to be used for generating a signature, and a fourth part which actually calculates the signature.

It will be appreciated that some or all of the processing steps carried out by the ADC 31 and/or the control and signature generation unit 36 may be carried out using a dedicated processing arrangement such as an application specific integrated circuit (ASIC) or a dedicated analog processing circuit. Alternatively or in addition, some or all of the processing steps carried out by the beam ADC 31 and/or control and signature generation unit 36 may be carried out using a programmable processing apparatus such as a digital signal processor or multi-purpose processor such as may be used in a conventional personal computer, portable computer, handheld computer (e.g. a personal digital assistant or PDA) or a smartphone. Where a programmable processing apparatus is used, it will be understood that a software program or programs may be used to cause the programmable apparatus to carry out the desired functions. Such software programs may be embodied onto a carrier medium such as a magnetic or optical disc or onto a signal for transmission over a data communications channel.

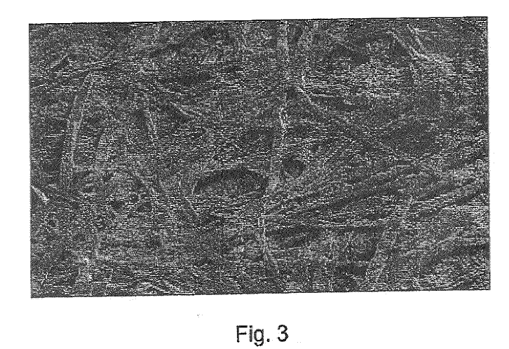

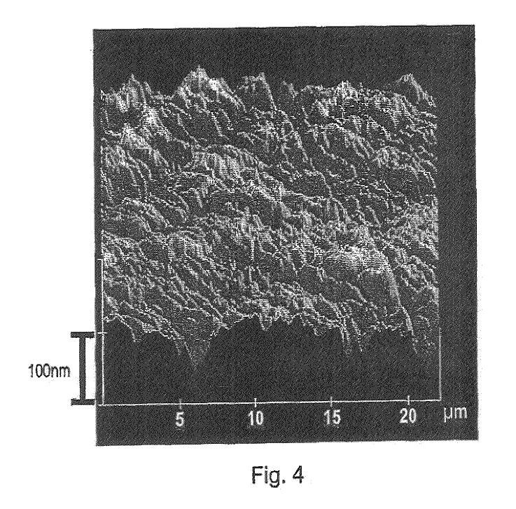

To illustrate the surface properties which the system of these examples can read, FIGS. 3 and 4 illustrate a paper and plastic article surface respectively.

FIG. 3 is a microscope image of a paper surface with the image covering an area of approximately 0.5×0.2 mm. This Figure is included to illustrate that macroscopically flat surfaces, such as from paper, are in many cases highly structured at a microscopic scale. For paper, the surface is microscopically highly structured as a result of the intermeshed network of wood or other plant-derived fibres that make up paper. The figure is also illustrative of the characteristic length scale for wood fibres which is around 10 microns. This dimension has the correct relationship to the optical wavelength of the coherent beam to cause diffraction and also diffuse scattering which has a profile that depends upon the fibre orientation. It will thus be appreciated that if a reader is to be designed for a specific class of goods, the wavelength of the laser can be tailored to the structure feature size of the class of goods to be scanned. It is also evident from the figure that the local surface structure of each piece of paper will be unique in that it depends on how the individual wood fibres are arranged. The structure of every piece of paper is unique as a result of it being made by a process governed by laws of nature. The same applies to many other types of article.

FIG. 4 shows an equivalent image for a plastic surface. This atomic force microscopy image clearly shows the uneven surface of the macroscopically smooth plastic surface. As can be surmised from the Figure, this surface is smoother than the paper surface illustrated in FIG. 3, but even this level of surface undulation can be uniquely identified using the signature generation scheme of the present examples.

Thus, a wide variety of every day articles have unique characteristics which are measurable in a straightforward manner. It is therefore essentially pointless to go to the effort and expense of making specially prepared scan-readable tokens for the purpose of uniquely identifying articles, as is known in the prior art.

The data collection and numerical processing of a scatter signal that takes advantage of the natural structure of an article's surface (or interior in the case of transmission) is now described.

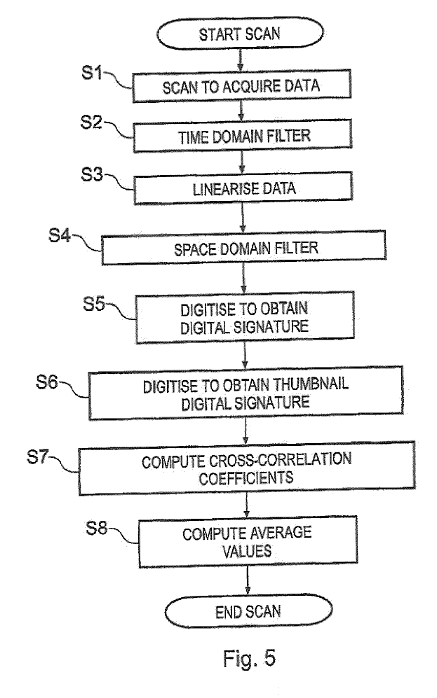

FIG. 5 shows a flow diagram showing how a signature of an article can be generated from a scan.

Step S1 is a data acquisition step during which the optical intensity at each of the photodetector elements is acquired at a number of locations along the entire length of scan. Simultaneously, an encoder signal may be acquired as a function of time, where the intensity reflected from a set of encoder markings of known spacing on the inside of the housing adjacent to the slit 10 or on the article is measured. This enables linearisation of the data collected by the photodetectors. It is noted that if the scan motor producing the required relative motion between the scan assembly and the article has a high degree of linearisation accuracy (e.g. as would a stepper motor), or if non-linearities in the data can be removed through block-wise analysis or template matching, then linearisation of the data may not be required.

Referring to FIG. 2 above, the photodetector data is acquired by the signature generator 36 taking data from the ADC 31. The number of data points per photodetector element collected in each scan is defined as N in the following. Further, the value ak(i) is defined as the i-th stored intensity value from photodetector k, where i runs from 1 to N.

Step S2 is an optional step of applying a time-domain filter to the captured data. In the present example, this is used to selectively remove signals in the 50/60 Hz and 100/120 Hz bands such as might be expected to appear if the target is also subject to illumination from sources other than the coherent beam. These frequencies are those most commonly used for driving room lighting such as fluorescent lighting.

Step S3 performs alignment of the data, including linearisation. In some examples, this step uses numerical interpolation to locally expand and contract ak(i) so that the measured encoder marking transitions are evenly spaced in time. This corrects for local variations in the motor speed and other non-linearities in the data. This step can be performed by the signature generator 36.

In some examples, where the scan area corresponds to a predetermined pattern template, the captured data can be compared to the known template and translational and/or rotational adjustments applied to the captured data to align the data to the template. This ensures that the signature of the article is read from the correct area. Also, stretching and contracting adjustments may be applied to the captured data to align it to the template in circumstances where the passage of the scan head relative to the article differs from that from which the template was constructed. Thus if the template is constructed using a defined linear scan speed, the scan data can be adjusted to match the template if the scan data was conducted with non-linearities of speed present, or at a different speed.

Step S4 applies a space-domain band-pass filter to the captured data. This filter passes a range of wavelengths in the x-direction (the direction of movement of the scan head). The filter is designed to maximise decay between samples and maintain a high number of degrees of freedom within the data. With this in mind, the lower limit of the filter passband is set to have a fast decay. This is required as the absolute intensity value from the target surface is uninteresting from the point of view of signature generation, whereas the variation between areas of apparently similar intensity is of interest. However, the decay is not set to be too fast, as doing so can reduce the randomness of the signal, thereby reducing the degrees of freedom in the captured data. The upper limit can be set high; whilst there may be some high frequency noise or a requirement for some averaging (smearing) between values in the x-direction, there is typically no need for anything other than a high upper limit. In some examples a second order filter can be used. In one example, where the speed of travel of the laser over the target surface is 20 mm per second, the filter may have an impulse rise distance 100 microns and an impulse fall distance of 500 microns.

Instead of applying a simple filter, it may be desirable to weight different parts of the filter. In one example, the weighting applied is substantial, such that a triangular passband is created to introduce the equivalent of real-space functions such as differentiation. A differentiation type effect may be useful for highly structured surfaces, as it can serve to attenuate correlated contributions (e.g. from surface printing on the target) from the signal relative to uncorrelated contributions.

Step S5 is a digitisation step where the multi-level digital signal (the processed output from the ADC) is converted to a bi-state digital signal to compute a digital signature representative of the scan. The digital signature is obtained in the present example by applying the rule: ak(i)>mean value maps onto binary ‘1’ and ak(i)<=mean value maps onto binary ‘0’. The digitised data set is defined as dk(i) where i runs from 1 to N.

The signature of the article may advantageously incorporate further components in addition to the digitised signature of the intensity data just described. These further optional signature components are now described.

Step S6 is an optional step in which a smaller ‘thumbnail’ digital signature is created. In some examples, this can be a real-space thumbnail produced either by averaging together adjacent groups of m readings, or by picking every cth data point, where c is the compression factor of the thumbnail. The latter may be preferable since averaging may disproportionately amplify noise. In other examples, the thumbnail can be based on a Fast Fourier Transform of some or all of the signature data. The same digitisation rule used in Step S5 is then applied to the reduced data set. The thumbnail digitisation is defined as tk(i) where i runs 1 to N/c and c is the compression factor.

Step S7 is an optional step applicable when multiple detector channels exist (i.e. where k>1). The additional component is a cross-correlation component calculated between the intensity data obtained from different ones of the photodetectors. With two channels there is one possible cross-correlation coefficient, with three channels up to three, and with four channels up to six, etc. The cross-correlation coefficients can be useful, since it has been found that they are good indicators of material type. For example, for a particular type of document, such as a passport of a given type, or laser printer paper, the cross-correlation coefficients always appear to lie in predictable ranges. A normalised cross-correlation can be calculated between ak(i) and al(i), where k≠1 and k, 1 vary across all of the photodetector channel numbers. The normalised cross-correlation function is defined as:

$$Γ ( k , l ) = \frac{{\sum }_{i = 1}^{N} {a}_{k} ( i ) {a}_{l} ( i )}{\sqrt{( {\sum }_{i = 1}^{N} {{a}_{k} ( i )}^{2} ) ( {\sum }_{i = 1}^{N} {{a}_{l} ( i )}^{2} )}}$$

Another aspect of the cross-correlation function that can be stored for use in later verification is the width of the peak of the cross-correlation function, for example the full width half maximum (FWHM). The use of the cross-correlation coefficients in verification processing is described further below.

Step S8 is another optional step which is to compute a simple intensity average value indicative of the signal intensity distribution. This may be an overall average of each of the mean values for the different detector elements or an average for each detector element, such as a root mean square (rms) value of ak(i). If the detector elements are arranged in pairs either side of normal incidence, an average for each pair of detectors may be used. The intensity value has been found to be a good crude filter for material type, since it is a simple indication of overall reflectivity and roughness of the sample. For example, one can use as the intensity value the un-normalised rms value after removal of the average value, i.e. the DC background. The rms value provides an indication of the reflectivity of the surface, in that the rms value is related to the surface roughness.

The signature data obtained from scanning an article can be compared against records held in a signature database for verification purposes and/or written to the such a database to add a new record of the signature to extend the existing database and/or written to the article in encoded form for later verification with or without database access.

A new database record will include the digital signature obtained in Step S5 as well as optionally its smaller thumbnail version obtained in Step S6 for each photodetector channel, the cross-correlation coefficients obtained in Step S7 and the average value(s) obtained in Step S8. Alternatively, the thumbnails may be stored on a separate database of their own optimised for rapid preliminary searching, and the rest of the data (including the thumbnails) on a main database.

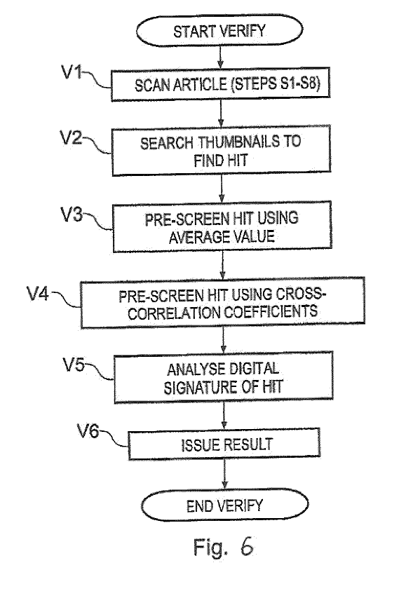

FIG. 6 is a flow diagram showing how a signature of an article obtained from a scan of an article can be verified against a signature database.

In a simple implementation, the database could simply be searched to find a match based on the full set of signature data. However, to speed up the verification process, the process of the present example uses the smaller thumbnails and pre-screening based on the computed average values and cross-correlation coefficients. To provide such a rapid verification process, the verification process is carried out in two main steps, firstly using thumbnails, in this case derived from the amplitude component of the Fourier transform of the scan data (and optionally also pre-screening based on the computed average values and cross-correlation coefficients), and secondly comparing the scanned and stored full digital signatures with each other.

Verification Step VI in FIG. 6 is the first step of the verification or authentication process, which is to scan an article according to the process described above, i.e. to perform Scan Steps S1 to S8. This scan obtains a signature for an article which is to be validated against one or more records of existing article signatures.

Verification Step V2 seeks a candidate match using the thumbnail derived from the Fourier transform amplitude component of the scan signal, which is obtained as explained above with reference to Scan Step S6. Verification Step V2 takes each of the thumbnail entries in the database and for each evaluates the number of matching bits between it and tk(i+j), where j is a bit offset which is varied to compensate for errors in placement of the scanned area. The value of j is determined and then the thumbnail entry which gives the maximum number of matching bits. This is a ‘hit’, to be used for further, more detailed, processing. A variation on this is to pass multiple candidate matches for full testing based on the full digital signature, thereby providing several “hits”. The thumbnail selection for this can be based on any suitable criteria, such as passing up to a maximum number, for example ten, of candidate matches, each candidate match being defined as the thumbnails with greater than a certain threshold percentage of matching bits, for example 60%. In the case that there are more than the maximum number of candidate matches, only the best ten are passed on. The result of the thumbnail search is a shortlist of one or more putative matches, each of which can then be tested against the full signature.

If no candidate match is found from the thumbnails, the article is rejected (i.e. jump to Verification Step V6 and issue a fail result).

This preliminary thumbnail-based searching method employed in the present example delivers an overall improved search speed. The thumbnail is smaller than the full signature, so it takes less time to search using the thumbnail than using the full signature. Where a real-space thumbnail is used, the thumbnail needs to be bit-shifted against the stored thumbnails to determine whether a “hit” has occurred, in the same way that the full signature is bit-shifted against the stored signature to determine a match. However, where the thumbnail is based on a Fourier Transform of the signature or part thereof, further advantages may be realised as there is no need to bit-shift the thumbnails during the search. A pseudo-random bit sequence, when Fourier transformed, carries some of the information in the amplitude spectrum and some in the phase spectrum. Any bit shift only affects the phase spectrum, however, and not the amplitude spectrum. Amplitude spectra can therefore be matched without any knowledge of the bit shift. Although some information is lost in discarding the phase spectrum, enough remains in order to obtain a rough match against the database. This allows one or more putative matches to the target to be located in the database. Each of these putative matches can then be compared properly using the conventional real-space method against the new scan as with the real-space thumbnail example.

Verification Step V3 is an optional pre-screening test that may be performed before analysing the full digital signature or signatures stored in the database against the scanned digital signature. In this pre-screen, the rms values obtained in Scan Step S8 are compared against the corresponding stored values in the database records of the hit(s). A ‘hit’ is rejected from further processing if the respective average values do not agree within a predefined range. If all ‘hits’ are rejected, the article is then rejected as non-verified (i.e. jump to Verification Step V6 and issue a fail result).

Verification Step V4 is a further optional pre-screening test that may be performed before analysing the full digital signature. The cross-correlation coefficients obtained in Scan Step S7 are compared against the corresponding stored values in the database records of the hit(s). A ‘hit’ is rejected from further processing if the respective cross-correlation coefficients do not agree within a predefined range. If all ‘hits’ are rejected, the article is then rejected as non-verified (i.e. jump to Verification Step V6 and issue fail result).

Another check using the cross-correlation coefficients that might be performed in Verification Step V4 (or later) is to check the width of the peak in the cross-correlation function, where the cross-correlation function is evaluated by comparing the value stored from the original scan in Scan Step S7 above and the re-scanned value:

$${Γ}_{k , l} ( j ) = \frac{{\sum }_{i = 1}^{N} {a}_{k} ( i ) {a}_{l} ( i + j )}{\sqrt{( {\sum }_{i = 1}^{N} {{a}_{k} ( i )}^{2} ) ( {\sum }_{i = 1}^{N} {{a}_{l} ( i )}^{2} )}}$$

If the width of the scanned peak is significantly larger than the width of the peaks of the ‘hits’, this may be taken as an indicator that the scanned article has been tampered with or is otherwise suspicious. For example, this check should beat a fraudster who attempts to fool the system by printing a bar code or other pattern with the same intensity variations that are expected by the photodetectors from the surface being scanned.

Verification Step V5 is the main comparison between the scanned digital signature obtained in Scan Step S5 and the corresponding stored values in the database record of the hit(s). The full stored digitised signature, dkdb(i) is split into n blocks of q adjacent bits on k detector channels, i.e. there are qk bits per block. As an example, a typical value for q is 4 and a typical value for k is in the range 1 to 2, making typically 4 to 8 bits per block. The qk bits are then matched against the qk corresponding bits in the stored digital signature dkdb(i+j). If the number of matching bits within the block is greater or equal to some pre-defined threshold zthresh, then the number of matching blocks is incremented. A typical value for zthresh is 7 on a two detector system. For a one detector system (k=1), zthresh might typically have a value of 3. This is repeated for all n blocks. This whole process is repeated for different offset values of j, to compensate for errors in placement of the scanned area, until a maximum number of matching blocks is found. Defining M as the maximum number of matching blocks, the probability of an accidental match is calculated by evaluating:

$$p ( M ) = {\sum }_{w = n - M}^{n} {{s}^{w} ( 1 - s )}^{n - w} {}_{w}^{n} C$$

where s is the probability of an accidental match between any two blocks (which in turn depends upon the chosen value of zthresh), M is the number of matching blocks and p(M) is the probability of M or more blocks matching accidentally. The value of s is determined by comparing blocks within the database from scans of different objects of similar materials, e.g. a number of scans of paper documents etc. For the example case of q=4, k=2 and zthresh=7, we find a typical value of s to be 0.1. If the qk bits were entirely independent, then probability theory would give s=0.01 for z threshold=7. The fact a higher value is found empirically is because of correlations between the k detector channels (where multiple detectors are used) and also correlations between adjacent bits in the block due to a finite laser spot width. A typical scan of a piece of paper yields around 314 matching blocks out of a total number of 510 blocks, when compared against the database entry for that piece of paper. Setting M=314, n=510 and s=0.1 for the above equation gives a probability of an accidental match of 10⁻¹⁷⁷. As mentioned above, these figures apply to a four detector channel system. The same calculations can be applied to systems with other numbers of detector channels.

Verification Step V6 issues a result of the verification process. The probability result obtained in Verification Step V5 may be used in a pass/fail test in which the benchmark is a pre-defined probability threshold. In this case the probability threshold may be set at a level by the system, or may be a variable parameter set at a level chosen by the user. Alternatively, the probability result may be output to the user as a confidence level, either in raw form as the probability itself, or in a modified form using relative terms (e.g. no match/poor match/good match/excellent match) or other classification. In experiments carried out upon paper, it has generally been found that 75% of bits in agreement represents a good or excellent match, whereas 50% of bits in agreement represents no match.

By way of example, it has been experimentally found that a database comprising one million records, with each record containing a 128-bit thumbnail of the Fourier transform amplitude spectrum, can be searched in 1.7 seconds on a standard PC computer of 2004 specification. Ten million entries can be searched in 17 seconds. High-end server computers can be expected to achieve speeds up to ten times faster than this.

It will be appreciated that many variations are possible. For example, instead of treating the cross-correlation coefficients as a pre-screen component, they can be treated together with the digitised intensity data as part of the main signature. The cross-correlation coefficients could be digitised and added to the digitised intensity data, for example. The cross-correlation coefficients could also be digitised on their own and used to generate bit strings or the like which could then be searched in the same way as described above for the thumbnails of the digitised intensity data in order to find the ‘hits’.

In one alternative example, step V5 (calculation of the probability of an accidental match) can be performed using a method based on an estimate of the degrees of freedom in the system. For example, if one has a total of 2000 bits of data in which there are 1300 degrees of freedom, then a 75% (1500 bits) matching result is the same as 975 (1300×0.75) independent bits matching. The uniqueness is then derived from the number of effective bits as follows:

$$p ( m ) = {\sum }_{w = n - m}^{n} {{s}^{w} ( 1 - s )}^{n - w} {}_{w}^{n} C$$

This equation is identical to the one indicated above, except that here m is the number of matching bits and p(m) is the probability of m or more blocks matching accidentally.

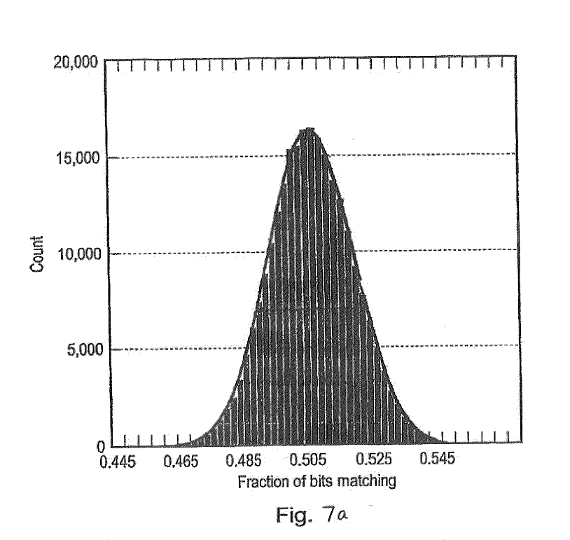

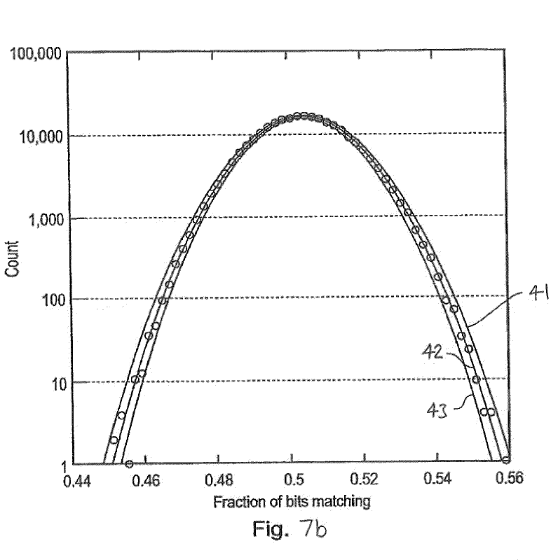

The number of degrees of freedom can be calculated for a given article type as follows. The number of effective bits can be estimated or measured. To measure the effective number of bits, a number of different articles of the given type are scanned and signatures calculated. All of the signatures are then compared to all of the other signatures and a fraction of bits matching result is obtained. An example of a histogram plot of such results is shown in FIG. 7a. The plot in FIG. 7a is based on 124,500 comparisons between 500 similar items, the signature for each item being based on 2000 data points. The plot represents the results obtained when different items were compared.

From FIG. 7a it can clearly be seen that the results provide a smooth curve centred around a fraction of bits matching result of approximately 0.5. For the data depicted in FIG. 7a, a curve can be fitted to the results, the mean of which curve is 0.504 and the standard deviation of which is 0.01218. From the fraction of bits matching plot, the number of degrees of freedom N can be calculated as follows:

$$N = μ \frac{1 - μ}{{σ}^{2}}$$

In the context of the present example, this gives a number of degrees of freedom N of 1685.

The accuracy of this measure of the degrees of freedom is demonstrated in FIG. 7b. This figure shows three binomial curves plotted onto the experimental fraction of bits matching. Curve 41 is a binomial curve with a turning point at 0.504 using N=1535, curve 42 is a binomial curve with a turning point at 0.504 using N=1685, and curve 43 is a binomial curve with a turning point at 0.504 using N=1835. It is clear from the plot that the curve 42 fits the experimental data, whereas curves 41 and 43 do not.

For some applications, it may be possible to make an estimate of the number of degrees of freedom rather than use empirical data to determine a value. If one uses a conservative estimate for an item, based on known results for other items made from the same or similar materials, then the system remains robust to false positives whilst maintaining robustness to false negatives.

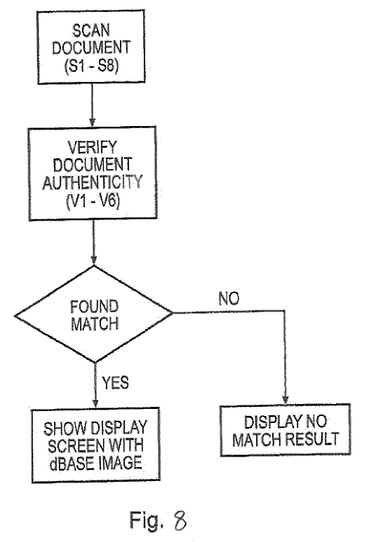

FIG. 8 is a flow diagram showing the overall process of how a document is scanned for verification purposes and the results presented to a user. First the document is scanned according to the scanning steps of FIG. 5. The document authenticity is then verified using the verification steps of FIG. 6. If there is no matching record in the database, a “no match” result can be displayed to a user. If there is a match, this can be displayed to the user using a suitable user interface. The user interface may be a simple yes/no indicator system such as a lamp or LED which turns on/off or from one colour to another for different results. The user interface may also take the form of a point of sale type verification report interface, such as might be used for conventional verification of a credit card. The user interface might be a detailed interface giving various details of the nature of the result, such as the degree of certainty in the result and data describing the original article or that article's owner. Such an interface might be used by a system administrator or implementer to provide feedback on the working of the system. Such an interface might be provided as part of a software package for use on a conventional computer terminal.

When a database match is found a user may also be presented with relevant information in an intuitive and accessible form which can allow the user to apply his or her own common sense for an additional, informal layer of verification. For example, if the article is a document, any image of the document displayed on the user interface (the image of the match found in the database) should look like the document presented to the verifying person. Other factors may be of interest, such as the confidence level and bibliographic data relating to document origin. The user will be able to apply their experience to make a value judgement as to whether these various pieces of information are self-consistent.

Alternatively or additionally, the output of a scan verification operation may be fed into some form of automatic control system rather than to a human operator. The automatic control system will then have the output result available for use in operations relating to the article from which the verified (or non-verified) signature was taken.

Thus there have now been described systems and methods for scanning an article to create a signature therefrom and for comparing a resulting scan to an earlier record signature of an article to determine whether the scanned article is the same as the article from which the record signature was taken. These methods can provide a determination of whether the article matches one from which a record scan has already been made to a very high degree of accuracy.

In summary, in an example system a digital signature is obtained by digitising a set of data points obtained by scanning a coherent beam over a paper, cardboard or other article, and measuring the scatter. A thumbnail digital signature is also determined, either in real-space by averaging or compressing the data, or by digitising an amplitude spectrum of a Fourier transform of the set of data points. A database of digital signatures and their thumbnails can thus be built up. The authenticity of an article can later be verified by re-scanning the article to determine its digital signature and thumbnail, and then searching the database for a match. Searching done on the basis of the Fourier transform thumbnail improves the search speed since, in a pseudo-random bit sequence, any bit shift only affects the phase spectrum, and not the amplitude spectrum, of a Fourier transform represented in polar co-ordinates. The amplitude spectrum stored in the thumbnail can therefore be matched without any knowledge of the unknown bit shift caused by registry errors between the original scan and the re-scan.

In some examples, the method for extracting a signature from a scanned article can be optimised to provide reliable recognition of an article despite deformations to that article caused by, for example, stretching or shrinkage such as from water damage to a paper or cardboard based article. Linearisation of the data can be used for this purpose.

Also, an article may appear to a scanner to be stretched or shrunk if the relative speed of the article to the sensors in the scanner is non-linear. This may occur if, for example the article is being moved along a conveyor system, or if the article is being moved through a scanner by a human holding the article. An example of a likely scenario for this to occur is where a human scans, for example, a bank card using a swipe-type scanner.

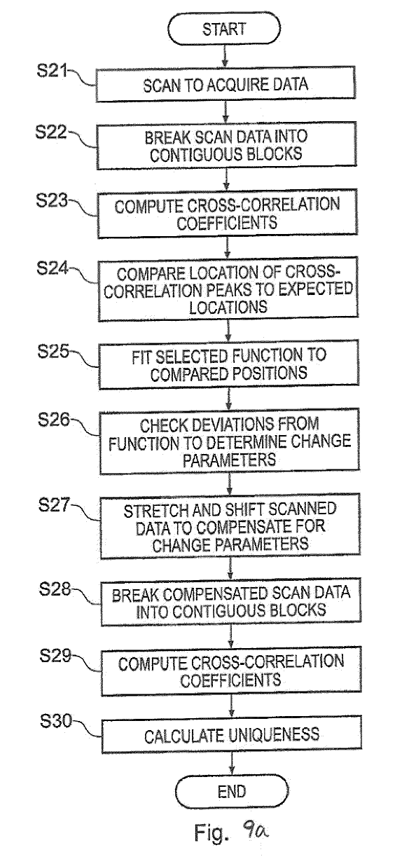

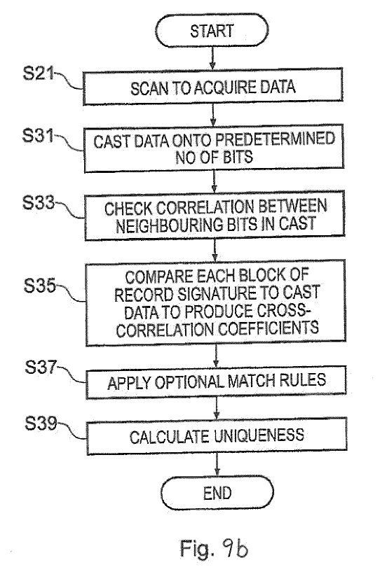

In some examples, where a reader is based upon a scan assembly which moves within the housing relative to an article held stationary against or in the housing, linearisation guidance (encoder markings) can be provided within the housing to address any non-linearities in the motion of the scan head. Where the article is moved by a human, these non-linearities can be greatly exaggerated To address recognition problems which could be caused by these non-linear effects, it is possible to adjust the analysis phase of a scan of an article. A validation procedure modified in this regard will now be described with reference to FIG. 9a. The process implemented in this example uses a block-wise analysis of the data to address the non-linearities.

The procedure carried out in accordance with FIG. 9a can include some or all of the steps of time domain filtering, alternative or additional linearisation, space domain filtering, smoothing and differentiating the data, and digitisation for obtaining the signature and thumbnail described with reference to FIG. 6, but are not shown in FIG. 9a so as not to obscure the content of that Figure.

As shown in FIG. 9a, the scanning process for a validation scan using a block-wise analysis starts at step S21 by performing a scan of the article to acquire the date describing the intrinsic properties of the article. This scanned data is then divided into contiguous blocks (which can be performed before or after digitisation and any smoothing/differentiation or the like) at step S22. In one example, a scan area of 1600 mm² (e.g. 40 mm×40 mm) is divided into eight equal length blocks. Each block therefore represents a subsection of the scanned area of the scanned article.

At step S23, for each of the blocks a cross-correlation is performed against the equivalent block for each stored signature with which it is intended that article be compared. This can be performed using a thumbnail approach with one thumbnail for each block. The results of these cross-correlation calculations are then analysed to identify the location of the cross-correlation peak. The location of the cross-correlation peak is then compared at step S24 to the expected location of the peak for the case where a perfectly linear relationship exists between the original and later scans of the article.

As this block-matching technique is a relatively computationally intensive process, in some examples its use may be restricted to use in combination with a thumbnail search such that the block-wise analysis is only applied to a shortlist of potential signature matches identified by the thumbnail search.

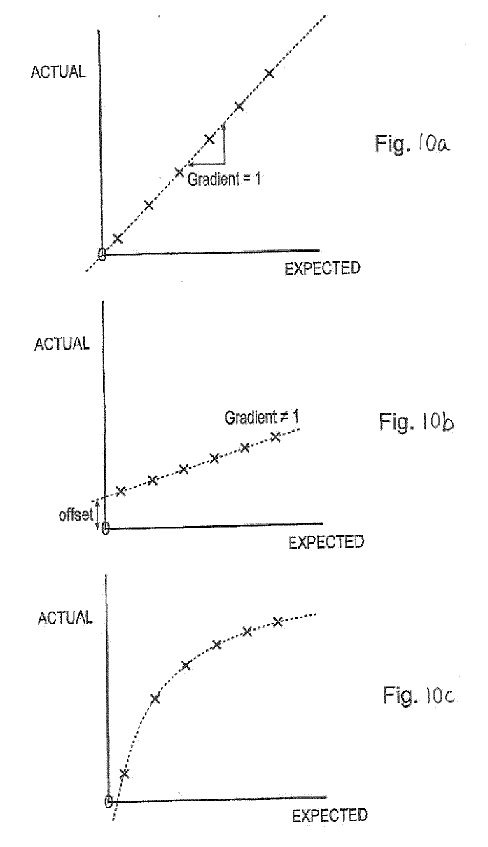

This relationship between the cross-correlation peaks can be represented graphically as shown in FIGS. 10a, 10b and 10c. In the example of FIG. 10a, the cross-correlation peaks are exactly where expected, indicating that the motion of the scan head relative to the article has been perfectly linear and the article has not experienced stretch or shrinkage. The plot of actual peak positions against expected peak results is a straight line which passes through the origin and has a gradient of 1.

In the example of FIG. 10b, the cross-correlation peaks are closer together than expected, such that the gradient of a line of best fit is less than 1. Thus the article has shrunk relative to its physical characteristics upon initial scanning. Also, the best fit line does not pass through the origin of the plot. Thus the article is shifted relative to the scan head compared to its position for the record scan.

In the example of FIG. 10c, the cross correlation peaks do not form a straight line. In this example, they approximately fit to a curve representing a y² function. Thus the movement of the article relative to the scan head has slowed during the scan. Also, as the best fit curve does not cross the origin, it is clear that the article is shifted relative to its position for the record scan.

A variety of functions can be test-fitted to the plot of points of the cross-correlation peaks to find a best-fitting function. Thus curves to account for stretch, shrinkage, misalignment, acceleration, deceleration, and combinations thereof can be used. Examples of suitable functions can include straight line functions, exponential functions, a trigonometric functions, quadratic functions and cubic functions.

Once a best-fitting function has been identified at step S25, at step S26 a set of compensation parameters can be determined which represent how much each cross-correlation peak is shifted from its expected position. These compensation parameters can then, at step S27, be applied to the data from the scan taken at step S21 in order substantially to reverse the effects of the shrinkage, stretch, misalignment, acceleration or deceleration on the data from the scan. As will be appreciated, the better the best-fit function obtained at step S25 fits the scan data, the better the compensation effect will be.

The compensated scan data is then broken into contiguous blocks at step S28 as in step S22. The blocks are then individually cross-correlated with the respective blocks of data from the stored signature at step S29 to obtain the cross-correlation coefficients. This time the magnitude of the cross-correlation peaks are analysed to determine the uniqueness factor at step S29. Thus it can be determined whether the scanned article is the same as the article which was scanned when the stored signature was created.

Using the above-described method for compensating for physical deformations in a scanned article and/or for non-linearities in the motion of the article relative to the scanner, a scanned article can be checked against a stored signature for that article obtained from an earlier scan of the article to determine with a high level of certainty whether or not the same article is present at the later scan. Thereby an article constructed from easily distorted material can be reliably recognised. Also, a scanner where the motion of the scanner relative to the article may be non-linear can be used, thereby allowing the use of a low-cost scanner without motion control elements.

An alternative method for performing a block-wise analysis of scan data is presented in FIG. 9b

This method starts at step S21 with performing a scan of the target surface as discussed above with reference to step S21 of FIG. 9a. Once the data has been captured, this scan data is cast onto a predetermined number of bits at step S31. This consists of an effective reduction in the number of bits of scan data to match the cast length. In the present example, the scan data is applied to the cast length by taking evenly spaced bits of the scan data in order to make up the cast data.

Next, step S33, a check is performed to ensure that there is a sufficiently high level of correlation between adjacent bits of the cast data. In practice, it has been found that correlation of around 50% between neighbouring bits is sufficient. If the bits are found not to meet the threshold, then the filter which casts the scan data is adjusted to give a different combination of bits in the cast data.

Once it has been determined that the correlation between neighbouring bits of the cast data is sufficiently high, the cast data is compared to the stored record signature at step S35. This is done by taking each predetermined block of the record signature and comparing it to the cast data. In the present example, the comparison is made between the cast data and an equivalent reduced data set for the record signature. Each block of the record signature is tested against every bit position offset of the cast data, and the position of best match for that block is the bit offset position which returns the highest cross-correlation value.

Once every block of the record signature has been compared to the cast data, a match result (bit match ratio) can be produced for that record signature as the sum of the highest cross-correlation values for each of the blocks. Further candidate record signatures can be compared to the cast data if necessary (depending in some examples upon whether the test is a 1:1 test or a 1:many test).

After the comparison step is completed, optional matching rules can be applied at step S37. These may include forcing the various blocks of the record signature to be in the correct order when producing the bit match ratio for a given record signature. For example if the record signature is divided into five blocks (block 1, block 2, block 3, block 4 and block 5), but the best cross-correlation values for the blocks, when tested against the cast data returned a different order of blocks (e.g. block 2, block 3, block 4, block 1, block 5) this result could be rejected and a new total calculated using the best cross-correlation results that keep the blocks in the correct order. This step is optional as, in experimental tests carried out, it has been seen that this type of rule makes little if any difference to the end results. This is believed to be due to the surface identification property operating over the length of the shorter blocks such that, statistically, the possibility of a wrong-order match occurring to create a false positive is extremely low.

Finally, at step S39, using the bit match ratio, the uniqueness can be determined by comparing the whole of the scan data to the whole of the record signature, including shifting the blocks of the record signature against the scan data based on the position of the cross-correlation peaks determined in step S35. This time the magnitude of the cross-correlation peaks are analysed to determine the uniqueness factor at step S39. Thus it can be determined whether the scanned article is the same as the article which was scanned when the stored record signature was created.

The block size used in this method can be determined in advance to provide for efficient matching and high reliability in the matching. When performing a cross-correlation between a scan data set and a record signature, there is an expectation that a match result will have a bit match ratio of around 0.9. A 1.0 match ratio is not expected due to the biometric-type nature of the property of the surface which is measured by the scan. It is also expected that a non-match will have a bit match ratio of around 0.5. The nature of the blocks as containing fewer bits than the complete signature tends to shift the likely value of the non-match result, leading to an increased chance of finding a false-positive. For example, it has been found by experiment that a block length of 32 bits moves the non-match to approximately 0.75, which is too high and too close to the positive match result at about 0.9 for many applications. Using a block length of 64 bits moves the non-match result down to approximately 0.68, which again may be too high in some applications. Further increasing the block size to 96 bits shifts the non-match result down to approximately 0.6, which for most applications provides more than sufficient separation between the true positive and false positive outcomes. As is clear from the above, increasing the block length increases the separation between non-match and match results as the separation between the match and non-match peaks is a function of the block length. Thus it is clear that the block length can be increased for greater peak separation (and greater discrimination accuracy) at the expense of increased processing complexity caused by the greater number of bits per block. On the other hand, the block length may be made shorter, for lower processing complexity, if less separation between true positive and false positive outcomes is acceptable.

Another characteristic of an article that can be detected using a block-wise analysis of a signature generated based upon an intrinsic property of that article is that of localised damage to the article. For example, such a technique can be used to detect modifications to an article made after an initial record scan.

For example, many documents, such as passports, ID cards and driving licenses, include photographs of the bearer. If an authenticity scan of such an article includes a portion of the photograph, then any alteration made to that photograph will be detected. Taking an arbitrary example of splitting a signature into ten blocks, three of those blocks may cover a photograph on a document and the other seven cover another part of the document, such as a background material. If the photograph is replaced, then a subsequent rescan of the document can be expected to provide a good match for the seven blocks where no modification has occurred, but the replaced photograph will provide a very poor match. By knowing that those three blocks correspond to the photograph, the fact that all three provide a very poor match can be used to automatically fail the validation of the document, regardless of the average score over the whole signature.

Also, many documents include written indications of one or more persons, for example the name of a person identified by a passport, driving license or identity card, or the name of a bank account holder. Many documents also include a place where written signature of a bearer or certifier is applied. Using a block-wise analysis of a signature scanned therefrom for validation can detect a modification to alter a name or other important word or number printed or written onto a document. A block which corresponds to the position of an altered printing or writing can be expected to produce a much lower quality match than blocks where no modification has taken place. Thus a modified name or written signature can be detected and the document failed in a validation test even if the overall match of the document is sufficiently high to obtain a pass result.

The area and elements selected for the scan area can depend upon a number of factors, including the element of the document which it is most likely that a fraudster would attempt to alter. For example, for any document including a photograph a likely alteration target will be the photograph as this visually identifies the bearer. Thus a scan area for such a document might beneficially be selected to include a portion of the photograph. Another element which may be subjected to fraudulent modification is the bearer's signature, as it is easy for a person to pretend to have a name other than their own, but harder to copy another person's signature. Therefore for signed documents, particularly those not including a photograph, a scan area may beneficially include a portion of a signature on the document.

In the general case therefore, it can be seen that a test for authenticity of an article can comprise a test for a sufficiently high quality match between a verification signature and a record signature for the whole of the signature, and a sufficiently high match over at least selected blocks of the signatures. Thus regions important to the assessing the authenticity of an article can be selected as being critical to achieving a positive authenticity result.

In some examples, blocks other than those selected as critical blocks may be allowed to present a poor match result. Thus a document may be accepted as authentic despite being torn or otherwise damaged in parts, so long as the critical blocks provide a good match and the signature as a whole provides a good match.

Thus there have now been described a number of examples of a system, method and apparatus for identifying localised damage to an article, and for rejecting as inauthentic an article with localised damage or alteration in predetermined regions thereof. Damage or alteration in other regions may be ignored, thereby allowing the document to be recognised as authentic.

For more details of the types of authentication system described thus far, the reader is directed to various published patent applications identified above.

It has been mentioned above that the captured data can be subjected to translational and/or rotational adjustments to align the data correctly with the orientation at which the signatures in the database were recorded, so that the comparison of signatures is more accurate. However, it has been found that this may not give satisfactory results. Correctional rotation of data which has been read at an incorrect angle is not equivalent to reading the data at the correct angle. This is because the property of a surface which causes the reproducible signature is dependent on the rotational alignment of the scan assembly with the surface (demonstrating further that the scan captures information relating to more than simply surface pattern).

Hence, a reader apparatus may be provided with an alignment guide or guides to aid the user in positioning the article correctly with respect to the scan assembly. This may be, for example, a simple angle bracket mounted on the exterior of the housing near the reading aperture, against which the user abuts the edges of the article. Other similar guide rails or receiving holes can be envisaged. However, this manual alignment increases the time and effort required from a user to read a signature from an article. The present invention aims to address this issue.

It is proposed to provide a reader apparatus with a camera operable to take an image of part or all of a surface of an article from which it is desired to read a signature. This image is then compared with a previously obtained image of an article of the same type or class, held in storage. This is a reference image, which includes the portion of the article's surface from which the signature can be read, which may be thought of as the scan area. Comparison of the captured image with the reference image reveals any misalignment between the reader and the article, either laterally or rotationally, or both. The captured image can be analysed to identify where within the imaged area the scan area lies. Any suitable image comparison technique may be used, such as pattern matching and recognition or simple pixel-by-pixel comparisons.

In addition to the camera, the scan assembly of the reader (comprising the laser source and the photodetector elements), referred to henceforth as the scan head, is mounted on a drive assembly operable to translate and rotate the scan head with respect to the area of the document which has been imaged. Using the information obtained by comparing the captured image with the reference image, control signals for the drive assembly can be determined, allowing the components within the scan head to be positioned in correct alignment with the scan area of the article. The scan area is then read by the scan head (where the motion of the scan head relative to the article necessary to obtain the scan data is produced either by the drive assembly or by a separate scanning drive), to produce data which can be used to generate the article's signature directly without the need for processing to compensate for misalignment. Also, the automation of obtaining a signature from an article is improved, as there is no need to require a user to carefully align the reader apparatus and the article prior to scanning.

Such an arrangement may, for example, be employed in a reader apparatus intended for hand-held use. If the camera, scan head and drive mechanism are housed within a small unit configured for hand-held use, with the reading aperture in one side, the unit can be placed against the article with the reading aperture facing the article without detailed reference on the part of the user to the precise area covered by the reader. This will facilitate the scanning of large quantities of articles, such as passports, identity cards, and articles being checked for customs or trading standards purposes. The higher the ratio between the area imaged by the camera and the scan area, the less accurate the user need be when placing the reader unit on the article, since the imaged area is more likely to contain the scan area.

FIG. 11 shows a simplified schematic representation of a reader apparatus 1 according to an example of this embodiment. Components of the apparatus already described are referred to by the same reference numerals as previously used. The apparatus 1 comprises a housing 12 having a reading aperture 10 in one wall. The reading aperture 10 is preferably a transparent window, so that the components within the housing 12 are protected. The reader apparatus 1 is placed against an article 51 to be scanned such that the reading aperture 10 is against the surface of the article 51 on which the scan area is located.

A scan head 20 comprising a laser source and photodetector elements is inside the housing, under the control of a control unit 36. The control unit 36 sends control signals to the scan head 20, and receives and processes the scan data read from the scan area. A signature database 54, accessible by the control unit 36, is also provided. This contains signatures against which a signature read from an article can be compared for authentication, and/or receives signatures read from articles so as to populate the database for use in future authentication.

Additionally, a camera 50 is housed in the housing 12, arranged to obtain an image of an article surface through the reading aperture 10. The camera 50 is also under control of the control unit 36 such that the control unit 36 operates the camera 50 to capture an image of the article 51, and then receives the captured image data. The control unit 36 includes a comparator (embodied as a circuit, as software, or both) that compares the captured image data with a reference image stored in memory 56 accessible by the control unit 36. The comparison allows the control unit 36 to determine the location and orientation of the scan area on the article surface relative to the area imaged by the camera 50. From this information, the control unit 36 generates control signals for the scan head 20.

The scan head 20 is provided with one or more drive mechanisms 52a, 52b, 52c operable to move the scan head over the region defined by the reading aperture 10. In this example, three drive mechanisms are provided. One provides linear movement in the x-direction, one provides linear movement in the y-direction, and one provides rotational movement in the x-y plane. Other examples may employ fewer or more drive mechanisms as required. For example, the movement may be limited to linear or rotational movement if this is deemed sufficient for a particular application. Any suitable drive mechanism can be used, depending on, for example, the required size, power, speed, and accuracy. Servo motors may be used, for example. In another example a single drive mechanism may be provided in the form of a servo stage operable to cause x, y translation and/or x-y plane rotational movement.

The control signals generated by the control unit 36 are sent to the drive mechanisms 52, which respond to move the scan head 20 into the correct linear and angular orientation for scanning of the scan area. Movement of the scan head 20 for the scan (to scan the laser beam relative to the article surface) may then be provided by the drive mechanisms 52. Alternatively, a separate drive for scanning may be provided.

In the present example the scan head 20 occupies a rest position (as shown in FIG. 11) while the camera 50 captures the image of the article, in which the scan head 20 is outside the field of view of the camera 50. The scan head 20 is then moved into position for scanning the scan area, and subsequently returned to the rest position when the scan is complete.

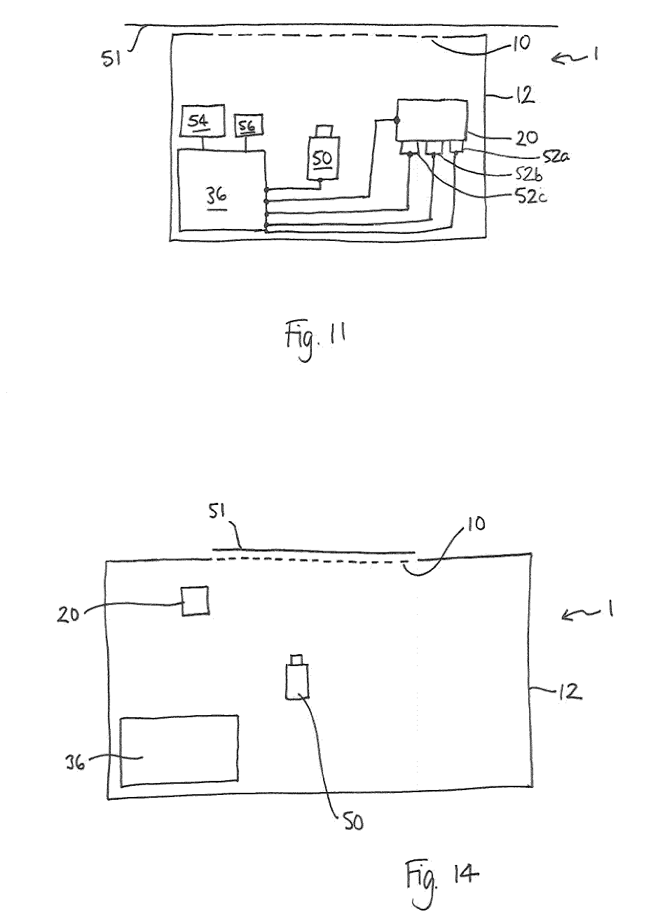

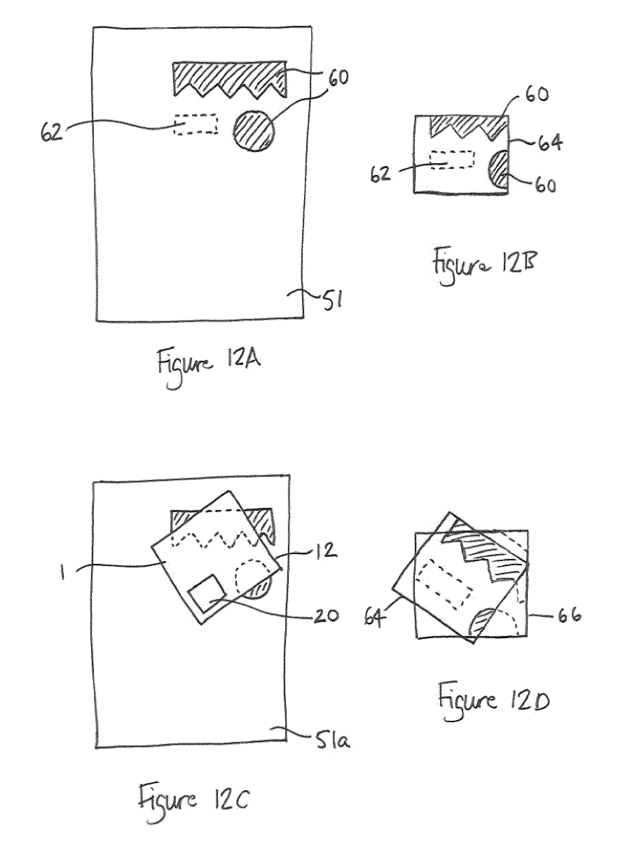

FIGS. 12A-12D illustrate an example article, reference image and captured image, and how these can be compared. FIG. 12A shows a surface of an article 51, for example the face of a document or a side of a box. The surface includes a pattern of dark shapes 60, in the vicinity of which a scan area 62 is defined. The shapes may be patterns, images, logos and/or text on the surface of the article. For example, the shapes may include a logo and printed text of a product name or similar on a commercial packaged item. The article is one of a class of articles having the same appearance, at least in the region of the scan area. The scan area 62 is shown as a dotted outline for the purpose of illustration only; on the real article the scan area may or may not be indicated.

FIG. 12B shows a reference image 64 obtained from one or more articles in the class. A single article might be imaged to obtain the reference image, or images of a plurality of articles may be captured and combined in some way, such as by averaging. This may provide a more representative reference image in which irregularities unique to any individual article are removed or made less significant. Alternatively, an artificially generated image that matches the appearance of the relevant part of the articles may be employed as the reference image. The reference image 64 includes the scan area 62, again indicated in dotted outline, and at least parts of the nearby shapes 60. The location of the scan area 62 within the reference image is known; this information forms part of the reference image data, or is stored with it. The reference image 62 should include sufficient detail of the pattern of the article around the scan area to allow the scan area to be unambiguously identified from an image of the pattern. The reference image 62 is stored in memory, either alone or as part of a database of reference images, which can be accessed by the control unit of a reader apparatus.

FIG. 12C shows an article 51a of the same class which is to have its signature read for authentication or to be added to a signature database. A user has placed a reader apparatus 1 against the article 51a, as shown by the outline of the housing 12. The reader apparatus is positioned only approximately over the region containing the scan area. Because of the placement of the apparatus 1, the scan head 20 of the apparatus 1 is not properly located for reading the scan area. It is displaced both linearly and rotationally. The camera of the reader apparatus 1 captures an image of the article 51a.

FIG. 12D shows the captured image 66, which includes the scan area 62 and parts of the neighbouring pattern 60. The control unit of the apparatus 1 compares the captured image 66 with the reference image 64. The two images are overlaid and adjusted until the patterns 60 are aligned. Then, the location of the scan area 62 within the area of the captured image 66 can be determined from the known location of the scan area 62 within the reference image 64. This information is then used to generate the control signals for correctly positioning and orienting the scan head 20 within the housing 12, so that the scan area 62 can be read at the correct alignment for the purpose of determining the signature of the article 51a.

Although the example shown in FIGS. 12A-12D shows a significant degree of rotational displacement and a relatively small amount of translation misalignment, the system described herein can be used to compensate for greater or lesser degrees of rotational and/or translational misalignment. For example, in the case of rotational misalignment, it has been discovered that a misalignment of only a few degrees can have a significant effect on the outcome of a scan result. Thus the arrangement described herein can, in some examples, provide adjustments of fractions of a degree of rotational adjustment in order to achieve the maximum possible accuracy from a scan result.

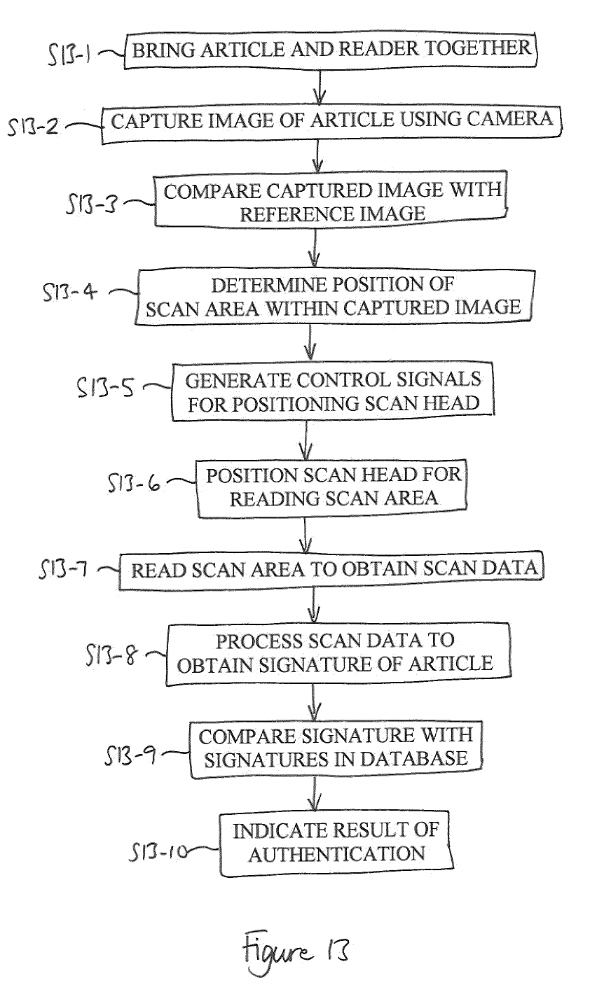

FIG. 13 shows a flow chart illustrating steps in a method according to an embodiment of the invention. In step S13-1, the article to be scanned is arranged for scanning with respect to the reader apparatus. In step S13-2, the surface of the article in the field of view of the reader apparatus is imaged using the camera in the reader apparatus. The captured image is then compared with a reference image for articles of the type or class to which the article to be scanned belongs, in step S13-3.

In step S13-4, the result of the image comparison is used to determine the position of the scan area on the article within the area of the article which has been captured in the image obtained by the camera. In step S13-5, this positional information is used to generate control signals for positioning the scan head in the reader apparatus. In step S13-6, the control signals are sent to the scan head, to position it correctly for reading the scan area on the article. Reading the scan area is performed in step S13-7.

The data obtained by reading the scan area is then processed in step S13-8 to obtain the signature for the article, followed by comparison of the signature with signatures for authentic articles stored in the signature database in step S13-9, and indicating to a user the result of the authentication in step S13-10, i.e. whether the scanned signature has been found to match a signature in the database and is therefore the signature of an authentic article. Steps S13-7 to S13-10 correspond to the method shown in FIG. 8. Alternatively, if the scanning is being performed for the purpose of populating a database with the signatures of authentic articles, the steps S13-9 and S13-10 are replaced by a step of storing the signature into the database.

In some examples, steps S13-2 to S13-6 may be performed as an iterative loop, to ensure that the adjustment applied at step S13-6 has achieved the desired alignment before making the scan.

An additional feature which may be implemented into a reader apparatus is to provide an alert to the user if the comparison between the captured image and the reference image reveals that the area on the article being accessed by the reader does not contain the scan area. The user then knows to reposition the reader unit, whereupon a new image is captured and compared with the reference image. This may happen if the user is being particularly careless, or has inadvertently positioned the article upside-down or back-to-front. The alert may be an auditory or visual signal, such as a buzzer or bleeper, a generated or pre-recorded spoken message, a light or lamp (such as an LED), or a message on a display panel. A further alert option is to arrange for the hand-held unit to vibrate in the hand of the user. The image comparison may also detect if the article is not of the class or type expected, such as a poor quality forgery, thereby providing a rapid high-level authenticity test without the need to read the scan area, process the signature data and search the signature database.

For a hand-held or otherwise compact unit, the data processing and comparison components and the controller for the driver assembly and scan drive (implemented as a single control unit in FIG. 11, but separate units may be used), the database(s), power supply and other parts may be included within the hand-held unit if suitable miniaturisation is possible, as shown in FIG. 11. Alternatively, any or all of these parts may be housed remotely in one or more external apparatuses with which the unit communicates via physical and/or wireless connections. For portable readers, the handheld unit or a proximate connected unit may be arranged to receive the relevant reference image and signature database for a particular class of articles to be scanned on a memory card or similar such that the reader can be configured specifically for a particular scanning application. This reduces the amount of memory required by the reader apparatus if it is to be used to a variety of scanning tasks. Alternatively, the apparatus can be configured such that the appropriate database and reference image can be downloaded onto some internal memory prior to a particular scanning operation, to be replaced later by the database and reference image needed for another operation.

To further reduce the size, weight and/or complexity of a portable apparatus, the reader may hold the appropriate reference image (either permanently or temporarily) in memory, and have other memory available for storing raw or minimally processed scan data obtained from one or more articles. The stored data can then be processed to generate the signatures for populating a signature database or authenticating the articles using processing and storage apparatus elsewhere. Such an arrangement would only be relevant to applications where an immediate authentication result is not required.

Other embodiments of the invention may be implemented in a larger apparatus, where the article is placed onto the apparatus rather than the opposite arrangement discussed in the preceding paragraphs. Such an apparatus may include, for example, a transparent imaging window onto which the appropriate surface of the article is placed, and through which the camera obtains the image for comparison with the reference image. The scan head and its drive assembly are positioned under the window with the camera, for movement to scan the scan area in response to the image comparison. Arrangements similar to those for photocopiers and document scanners might be employed, for example. Indeed, if an automatic document feeder is provided to feed papers onto the imaging window, a large quantity of documents can be scanned for either testing or initial signature recordal entirely automatically. Other automatic feeder systems can be employed for bulk scanning of larger articles.

FIG. 14 shows a simplified schematic representation of an example larger reader apparatus. The apparatus 10 comprises an outer housing 12 which may be free-standing, or configured to rest on a table or counter, depending on size. As in the example of FIG. 11, a camera 50, a movable scan head 20 and a control unit 36 are mounted inside the housing 12 (other components are omitted from the Figure for simplicity). The larger size of the apparatus 1 can offer more scope for providing a rest position for the scan head 20 that does not obstruct the field of view of the camera 50.

A transparent window 10 is provided in the upper wall of the housing 12, through which the camera 50 and the scan head 20 access the article. The article 51, in this example shown as a document, is placed on the window 10 with the surface having the scan area facing downwards for imaging by the camera 50 and scanning by the scan head 20. The article need not cover the whole surface of the window, but imaging by the camera may be improved if extraneous light around the edge of article is blocked, so a shield fitting over or around the article may be provided. As mentioned above, a feeder system (not shown) may be included to supply a stream of articles for imaging and scanning. Otherwise, the apparatus of FIG. 14 can operate in the same manner as that of FIG. 11.

A larger apparatus will typically have all the processing, control, power and memory components housed within it, but may have one or more parts provided in an external apparatus as discussed above for portable units.

In embodiments in which the apparatus is large enough for the camera to image the whole of the surface of the article containing the scan area, there is no requirement for the user to be made aware of the location of the scan area. The camera and the drive arrangement for the scan head provide automatic locating and scanning of the scan area. This not only reduces the handling time for each document (because no alignment of the scanner and article is needed), but also improves security, since the number of personnel who need knowledge of scan area location is reduced. Depending on the size of the article, this may be possible with a hand-held reader, or a larger reader may be required.

Depending on the number of scanning applications for which a scanner is intended, the scanner may contain a database of different reference images for different classes of article. The image comparison for identifying the position of the scan area may include a preliminary step of searching the reference image database for an image match. If many articles of the same class are to be scanned, however, the scanning can be made faster by retrieval and temporary storage of the appropriate reference image from the database before scanning begins, or as a step in the scanning of the first article.

To implement the image comparison, articles need to have a recognisable pattern discernable by optical inspection (inspection by camera, which may or may not operate at visible wavelengths) in the vicinity of the scan area which is included in the reference image. Articles may be specially printed with a suitable pattern or markings. This could be an alignment mark intended to indicate the location of the scan area, a random mark or pattern without obvious meaning, or a meaningful mark such as a security hologram or other security mark which serves another purpose and which does not appear to be an alignment mark. The latter options disguise the location of the scan area from the uninitiated, thereby enhancing security. Alternatively, pre-existing surface patterns or markings may be employed, such as the indicia or logos on branded goods or official documents. The pattern or marking included in the reference image need not be printed onto the article, but may be integrated with the article in any manner suitable for imaging, such as a marking stuck onto the surface of the article or otherwise attached, or embedded or otherwise incorporated into the surface. In some examples, one or more marks on the article surface which are associated with the signature scan area (either in the form of an alignment mark, in the form of an area which is scanned to produce the signature, or both) may be an area of the article which is legally protected in some manner. For example, association with a copyright or trademarked logo, or with some coding or information which is a matter of regulatory compliance can be expected to impede actions by a forger, smuggler or other person attempting to circumvent the security/authentication/tracking system from doing so.

The reference image may be smaller than the captured image; this increases the likelihood that the captured image will contain all or most of the reference image, making identification of the reference image area within the captured image more accurate.

Thus, the present invention provides improved apparatus for authentication of articles from optical scatter measurements, which automatically aligns the scanning part of the apparatus with the surface region of interest on the article so that a signature can be obtained from an article more quickly and accurately with reduced user skill and input.

1. A system for obtaining a signature from an article, the article having a scan area on a surface of the article from which a signature of the article may be read, the system comprising:
a signature generator comprising a scan head having:
an optical source operable to direct coherent radiation onto a plurality of regions in the scan area; and
a detector arrangement operable to collect a set comprising groups of data points by detecting scattered coherent radiation from the regions in the scan area, wherein different ones of the groups of data points relate to scatter from the respective different regions of the scan area;
the signature generating operable to determine a signature of the article from the set of data points;
a camera operable to capture an image of the surface of the article;
an image comparator operable to compare the captured image with a reference image of an article of the same class which includes the scan area of that article, to determine the location and orientation of the scan area on the said article; and
a drive assembly operable to position the scan head in a location and orientation suitable for generating a signature from the scan area on the article, in response to the determination of the location and orientation of the scan area.

2. A system according to claim 1, further comprising:
a signature comparator operable to compare the signature of the article with one or more stored signatures of articles; and
a determiner operable to determine an authentication result based on the result of the comparison by the signature comparator.

3. A system according to claim 1, in which the drive assembly is operable to translate, rotate, or translate and rotate the scan head to position the scan head.

4. A system according to claim 1, in which the drive assembly is further operable to move the scan head relative to the article to collect the data points.

5. A system according to claim 1, in which at least the scan head, the camera and the drive assembly are arranged within a housing suitable for hand-held use in which a user can place the housing against a surface of an article.

6. A system according to claim 1, in which at least the scan head, the camera and the drive assembly are arranged within a housing onto which an article can be placed for imaging and generation of its signature.

7. A system according to claim 6, in which an automatic article feeder is mounted on the housing, operable to supply a succession of articles onto the housing.

8. A system according to claim 1, further comprising an alert device operable to deliver an alert signal to a user in the event that the image comparator is unable to determine the location and position of the scan area from the captured image.

9. A system according to claim 1, in which the reference image is an image of a single article of the same class.

10. A system according to claim 1, in which the reference image is an image composed from two or more images of articles of the same class.

11. A system according to claim 1, in which the reference image is held in a database of reference images of articles of different classes.

12. A system according to claim 1, in which the reference image is smaller in area than the captured image.

13. A system according to claim 1, in which the camera is able to capture an image of the entirety of the surface of the article having the scan area.

14. A method for obtaining a signature from an article, the article having a scan area on a surface of the article from which a signature of the article may be read, the method comprising:
capturing an image of the surface of the article;
comparing the captured image with a reference image of an article of the same class which includes the scan area of that article, to determine the location and orientation of the scan area on the said article; and
generating a signature from the article by directing coherent radiation onto a plurality of regions in the scan area; collecting a set comprising groups of data points from signals obtained when the coherent radiation scatters from the regions in the scan area wherein different ones of the groups of data points relate to scatter from the respective different regions of the scan area; and determining a signature of the article from the set of data points; the signature being generated using a scan head comprising an optical source operable to direct coherent radiation onto the scan area and a detector arrangement operable to collect the data points by detecting the scattered coherent radiation; wherein the scan head is positioned in a location and orientation suitable for generating a signature from the scan area on the article in response to the determination of the location and orientation of the scan area.

15. A method according to claim 14, further comprising:
comparing the signature of the article with one or more stored signatures of articles; and
determining an authentication result based on the result of the signature comparison.

16. A method according to claim 14, in which the reference image is an image of a single article of the same class.

17. A method according to claim 14, in which the reference image is an image composed from two or more images of articles of the same class.

18. A method according to claim 14, in which the reference image is retrieved from a database of reference images of articles of different classes.

19. A method according to claim 14, in which the reference image is smaller in area than the captured image.

20. A method according to claim 14, in which the captured image is an image of the entirety of the surface of the article having the scan area.
